(19) United States
(12) Patent Application Publication
(10) Pub. No.: US 2024/0292186 A1
(43) Pub. Date: Aug. 29, 2024

(54) METHOD FOR LOCATION SERVICE IN EDGE COMPUTING

(71) Applicant: ZTE CORPORATION, Shenzhen (CN)

(72) Inventors: Jinguo ZHU, Shenzhen (CN); Zhijun LI, Shenzhen (CN); Wanpeng FAN, Shenzhen (CN); Shijun CHEN, Shenzhen (CN)

(73) Assignee: ZTE CORPORATION, Shenzhen (CN)

(21) Appl. No.: 18/431,052

(22) Filed: Feb. 2, 2024

Related U.S. Application Data
(63) Continuation of application No. PCT/CN2021/112578, filed on Aug. 13, 2021.

(51) Int. Cl. H04W 4/029

(52) U.S. Cl. CPC H04W 4/029

(57) ABSTRACT

A wireless communication method for use in a location management function is disclosed. The method comprises receiving a request for location information associated with a wireless terminal, establishing a direct connection with a wireless network node serving the wireless terminal, transmitting, to the wireless network node via the direct connection, a downlink network positioning message for the location information associated with the wireless terminal, receiving, from the wireless network node via the direct connection, an uplink network positioning message comprising the location information associated with the wireless terminal, and transmitting the location information associated with the wireless terminal.

### CROSS-REFERENCE TO RELATED PATENT APPLICATIONS

This application is a Continuation of PCT Application No. PT/CN2021/112578, filed Aug. 13, 2021, incorporated herein by reference in its entirety.

### TECHNICAL FIELD

This document is directed generally to wireless communications, and in particular to a location service in edge computing.

### BACKGROUND

In a location service (LCS) procedure, a location of a user equipment (UE) is calculated in a location management function (LMF) which is deployed in the public network. In some deployments, e.g., at private enterprise, UE location data is sensitive data and a data owner may not want to expose the UE location data to the public network. Thus, a solution of supporting the LCS without exposing the UE location data to the public network may be needed.

### SUMMARY

This document relates to methods, systems, and devices for the LCS in edge computing, and in particular to methods, systems, and devices in control plane for the LCS in edge computing.

The present disclosure relates to a wireless communication method for use in a location management function. The method comprises:
receiving a request for location information associated with a wireless terminal,
establishing a direct connection with a wireless network node serving the wireless terminal,
transmitting, to the wireless network node via the direct connection, a downlink network positioning message for the location information associated with the wireless terminal,
receiving, from the wireless network node via the direct connection, an uplink network positioning message comprising the location information associated with the wireless terminal, and
transmitting, to the application function, the location information associated with the wireless terminal.

Various embodiments may preferably implement the following features:

Preferably or in some embodiments, establishing the direct connection with the wireless network node serving the wireless terminal comprises:
receiving, from the wireless network node via at least one core network function, node information of the wireless network node and a node correlation identifier associated with the wireless terminal at the wireless network node, and
transmitting, to the wireless network node via the direct connection, a function correlation identifier associated with the request for the location information at the location management function.

Preferably or in some embodiments, the direct connection is established by the location management function based on the node information of the wireless network node.

Preferably or in some embodiments, the wireless communication method further comprises transmitting, to the wireless network node via the at least one core network function, a routing identifier associated with the location management function.

Preferably or in some embodiments, establishing the direct connection with the wireless network node serving the wireless terminal comprises:
transmitting, to the wireless network node via at least one core network function, a routing identifier associated with the location management function and a function correlation identifier associated with the request for the location information at the location management function, and
receiving, from the wireless network node via the direct connection, a node correlation identifier associated with the wireless terminal at the wireless network node.

Preferably or in some embodiments, the node correlation identifier and the function correlation identifier are next generation application protocol user equipment identifiers of the wireless terminal.

Preferably or in some embodiments, the wireless communication method further comprises:
receiving, from the wireless network node, a transport message indicating a handover associated with the wireless terminal, and
establishing a direct connection with a target wireless network node of the handover.

The present disclosure relates to a wireless communication method for use in a wireless network node. The method comprises:
establishing a direct connection with a location management function,
receiving, from the location management function via the direct connection, a downlink network positioning message for location information associated with a wireless terminal, and
transmitting, to the location management function via the direct connection, an uplink network positioning message comprising the location information associated with the wireless terminal.

Various embodiments may preferably implement the following features:

Preferably or in some embodiments, establishing the direct connection with the location management function comprises:
transmitting, to the location management function via at least one core network function, node information of the wireless network node and a node correlation identifier associated with the wireless terminal at the wireless network node, and
receiving, from the location management function via the direct connection, a function correlation identifier associated with the request for the location information at the location management function.

Preferably or in some embodiments, the wireless communication method further comprises receiving, from the location management function via the at least one core network function, a routing identifier associated with the location management function.

Preferably or in some embodiments, establishing the direct connection with the location management function comprises:
receiving, from the location management function via at least one core network function, a routing identifier associated with the location management function and a function correlation identifier associated with the request for the location information at the location management function, and
transmitting, to the location management function via the direct connection, a node correlation identifier associated with the wireless terminal at the wireless network node.

Preferably or in some embodiments, the direct link is established by the wireless network node based on the routing identifier.

Preferably or in some embodiments, the node correlation identifier and the function correlation identifier are next generation application protocol user equipment identifiers of the wireless terminal.

Preferably or in some embodiments, a handover associated with the wireless network node is performed, and the wireless communication method further comprises transmitting, to the location management function, a transport message indicating the handover.

The present disclosure relates to a wireless communication method for use in a gateway mobile location centre. The method comprises:
receiving, from a location management function, a location service request for location information of a wireless terminal, wherein the location service request comprises a routing identifier associated with the location management function, and
transmitting, to an access and mobility management function, a location information request associated with the wireless terminal, wherein the location information request comprises the routing identifier.

Various embodiments may preferably implement the following features:
Preferably or in some embodiments, the wireless communication method further comprises:
receiving, from the access and mobility management function, a location information response comprising node information of a wireless network node and a node correlation identifier associated with the wireless terminal at the wireless network node, and
transmitting, to the location management function, a location service response comprising the node information and the node correlation identifier.

Preferably or in some embodiments, the location service request and the location information request comprise a function correlation identifier associated with a request for the location information at the location management function.

The present disclosure relates to a wireless communication method for use in an access and mobility management function. The method comprises:
receiving, from a gateway mobile location centre, a location information request for location information of a wireless terminal, wherein the location information request comprises a routing identifier associated with a location management function, and
transmitting, to a wireless network node, a connection establishing request comprising the routing identifier.

Various embodiments may preferably implement the following features:

Preferably or in some embodiments, the wireless communication method further comprises:
receiving, from the wireless network node, a connection establishing response comprising a node correlation identifier associated with the wireless terminal at the wireless network node, and
transmitting, to the gateway mobile location centre, a location information response comprising node information of the wireless network node and the node correlation identifier.

Preferably or in some embodiments, the location information request and the connection establishing request comprise a function correlation identifier associated with identifying a request for the location information at the location management function.

The present disclosure relates to a wireless device comprising a location management function. The wireless network comprises:
a communication unit, configured to receive a request for location information associated with a wireless terminal, and
a processor, configured to establish a direct connection with a wireless network node serving the wireless terminal,
wherein the communication unit is further configured to:
transmit, to the wireless network node via the direct connection, a downlink network positioning message for the location information associated with the wireless terminal,
receive, from the wireless network node via the direct connection, an uplink network positioning message comprising the location information associated with the wireless terminal, and
transmit the location information associated with the wireless terminal.

Various embodiments may preferably implement the following feature:

Preferably or in some embodiments, the processor is configured to perform any of aforementioned wireless communication methods.

The present disclosure relates to a wireless network node. The wireless network node comprises:
a processor, configured to establish a direct connection with a location management function,
a communication unit, configured to:
receive, from the location management function via the direct connection, a downlink network positioning message for location information associated with a wireless terminal, and
transmit, to the location management function via the direct connection, an uplink network positioning message comprising the location information associated with the wireless terminal.

Various embodiments may preferably implement the following feature:

Preferably or in some embodiments, the processor is configured to perform any of aforementioned wireless communication methods.

The present disclosure relates to a wireless device comprising a gateway mobile location centre. The wireless device comprises:
a communication unit, configured to:
receive, from a location management function, a location service request for location information of a wireless terminal, wherein the location service request comprises a routing identifier associated with the location management function, and
transmit, to an access and mobility management function, a location information request associated with the wireless terminal, wherein the location information request comprises the routing identifier.

Various embodiments may preferably implement the following feature:

Preferably or in some embodiments, the wireless device further comprises a processor configured to perform any of aforementioned wireless communication methods.

The present disclosure relates to a wireless device comprising an access and mobility management function. The wireless device comprises:
a communication unit, configured to:
receive, from a gateway mobile location centre, a location information request for location information of a wireless terminal, wherein the location information request comprises a routing identifier associated with a location management function, and
transmit, to a wireless network node, a connection establishing request comprising the routing identifier.

Various embodiments may preferably implement the following feature:

Preferably or in some embodiments, the wireless device further comprises a processor configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a location service architecture according to an embodiment of the present disclosure.

FIG. 2 shows a schematic diagram of a mobile terminated location request service procedure according to an embodiment of the present disclosure.

FIG. 3 shows a schematic diagram of a location service architecture according to an embodiment of the present disclosure.

FIG. 4 shows a schematic diagram of a mobile terminated location request procedure according to an embodiment of the present disclosure.

FIG. 5 shows a schematic diagram of a mobile terminated location request procedure according to an embodiment of the present disclosure.

FIG. 6 shows a schematic diagram of a mobility procedure according to an embodiment of the present disclosure.

FIG. 7 shows an example of a schematic diagram of a wireless terminal according to an embodiment of the present disclosure.

FIG. 8 shows an example of a schematic diagram of a wireless network node according to an embodiment of the present disclosure.

FIG. 9 shows a flowchart of a method according to an embodiment of the present disclosure.

FIG. 10 shows a flowchart of a method according to an embodiment of the present disclosure.

FIG. 11 shows a flowchart of a method according to an embodiment of the present disclosure.

FIG. 12 shows a flowchart of a method according to an embodiment of the present disclosure.

### DETAILED DESCRIPTION

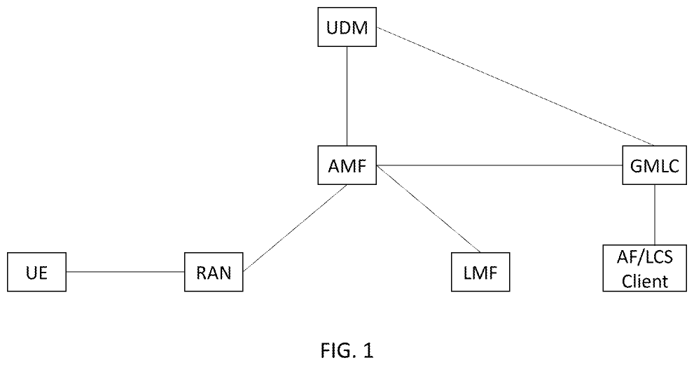

FIG. 1 shows a schematic diagram of a location service (LCS) architecture according to an embodiment of the present disclosure. The LCS architecture comprises the following network functions and entities:

1) UE (user equipment): The UE can provide UE assistant information to LMF so the LMF can calculate the UE location.

2) RAN (radio access network): The RAN is involved in the handling of various positioning procedures including positioning of a target UE, provision of location related information not associated with a particular target UE and transfer of positioning messages between the target UE and an access and mobility management function (AMF) or a location management function (LMF). The RAN supports determination of location estimations in geographical and/or local co-ordinates. In this embodiment, the RAN may refer to RAN node.

3) AMF (access and mobility management function): The AMF includes the following functionalities: registration management, connection management, reachability management and mobility management. The AMF also performs the access authentication and access authorization. The AMF is a non-access stratum (NAS) security termination. The AMF can relay the NAS between UE and LMF, etc. The AMF also selects a proper LMF when receiving a location request from the GMLC.

4) UDM (user data management): This function provides UE subscription information to the GMLC. The UDM also maintains the serving AMF information that the UE is currently registered. Thus, when the UE subscription is updated, the UDM is able to provide the updated UE subscription to the AMF. The UDM contains LCS subscriber LCS privacy profile. In the present disclosure, the UDM may be collocated with an UDR (user data repository).

5) LMF (location management function): The LMF calculates and/or verifies the UE location and any velocity estimation and may estimate the achieved accuracy. The LMF receives location requests for a target UE from the serving AMF. The LMF interacts with the UE to exchange location information applicable to UE assisted and UE based position methods and interacts with the RAN in order to obtain the location information of the target UE.

6) GMLC (gateway mobile location centre): The GMLC contains functionalities required to support LCS. The GMLC is the first node accessed by an external LCS client (i.e., application function (AF)) in a public land mobile network (PLMN). The AFs and network functions (NFs) may access the GMLC directly or via a network exposure function (NEF). The GMLC may request routing information and/or target UE privacy information from the UDM. After performing authorization of an external LCS client or AF and verifying target UE privacy information, the GMLC forwards a location request to a serving AMF.

7) AF/LCS client: The AFs/LCS clients and NFs may access LCS services from the GMLC.

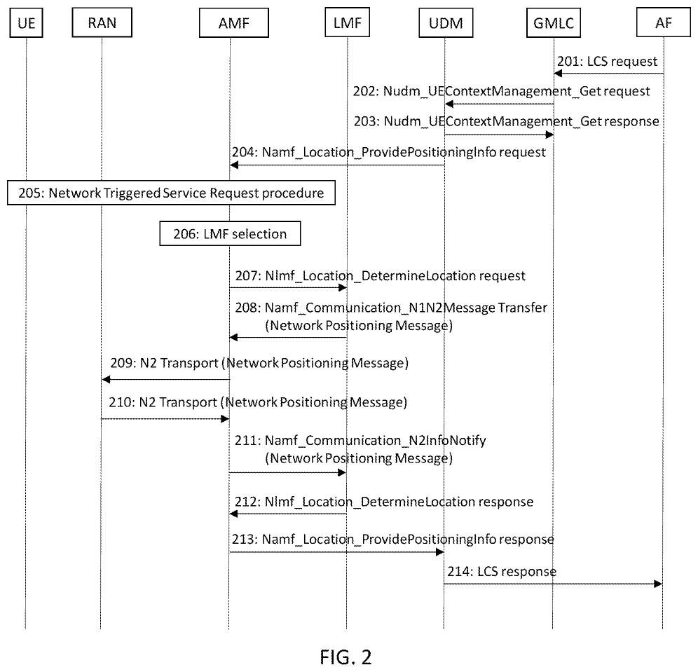

FIG. 2 shows a schematic diagram of a mobile terminated location request service procedure according to an embodiment of the present disclosure. The mobile terminated location request service procedure shown in FIG. 2 comprises the following steps:

Step 201: The external LCS client (i.e., AF) sends a LCS request to the GMLC for a location (information) of a target UE. In an embodiment, the target UE is identified by a GPSI (Generic Public Subscription Identifier) or a SUPI (subscription permanent identifier).

Step 202: The GMLC invokes a Nudm_UECM_Get service operation towards the home UDM of the target UE being located with the GPSI or the SUPI.

Step 203: The UDM returns a network addresses of the current serving AMF of the target UE.

Step 204: The GMLC invokes a Namf_Location_ProvidePositioningInfo service operation towards the AMF to request the current location of the UE. The service operation includes the SUPI, and client type and may include the required QoS and Supported GAD shapes.

Step 205: If the UE is in a connection management idle (CM IDLE) state, the AMF initiates a network triggered Service Request procedure to establish a signaling connection with the UE.

Step 206: The AMF selects an LMF based on the available information or based on AMF local configuration. The LMF selection may take the RAN currently serving the UE into account. The AMF may also query an NRF (Network Repository Function) to select the LMF.

Step 207: The AMF invokes a Nlmf_Location_DetermineLocation service operation towards the LMF to request the current location of the UE. The service operation includes an LCS Correlation identifier, the serving cell identity of the RAN, and the client type, the required QoS, UE Positioning Capability, if available, and Supported GAD shapes. The service operation may also include the AMF identity.

Step 208: The LMF invokes the Namf_Communication_N1N2MessageTransfer service operation towards the AMF to request the transfer of a Network Positioning message to the serving RAN node for the UE. The service operation includes the Network Positioning message and the LCS Correlation identifier. The Network Positioning message may request the location information for the target UE from the RAN.

Step 209: The AMF forwards the Network Positioning message to the serving RAN node in an N2 Transport message. The AMF includes a Routing identifier identifying/indicating the LMF (e.g., a global address of the LMF) in the N2 Transport message.

Step 210: The RAN node obtains any location information for the UE requested. The serving RAN node returns any location information to the AMF in a Network Positioning message included in an N2 Transport message. The serving RAN node shall also include the Routing identifier in the N2 Transport message received in step 209.

Step 211: The AMF invokes the Namf_Communication_N2InfoNotify service towards the LMF indicated by the routing identifier. The service operation includes the Network Positioning message and the LCS Correlation identifier. Steps 208 to 211 may be repeated to request further location information and further RAN capabilities.

Step 212: The LMF returns the Nlmf_Location_DetermineLocation Response towards the AMF to return the current location of the UE. The service operation includes the LCS Correlation identifier, the location estimate, its age and accuracy and may include information about the positioning method.

Step 213: The AMF returns the Namf_Location_ProvidePositioningInfo Response towards the GMLC to return the current location of the UE. The service operation includes the location estimate, its age and accuracy and may include information about the positioning method.

Step 214: The GMLC sends the LCS response to the external location services client.

In FIG. 2, the UE location is calculated in the LMF which is deployed in the core network. In some embodiments, a local network provider (e.g., an enterprise) may not want to expose the UE location information to outside of a local area of the provided network.

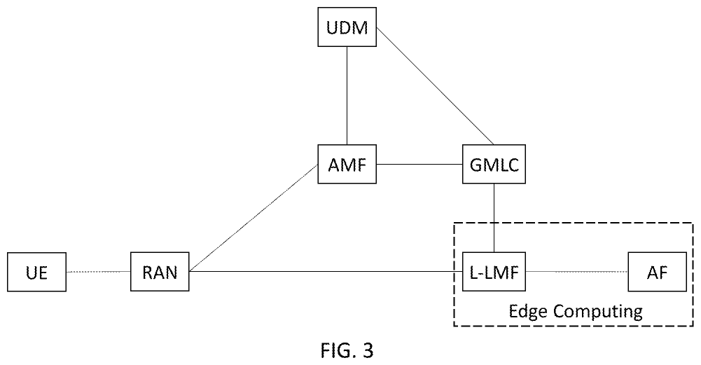

FIG. 3 shows a schematic diagram of a network architecture according to an embodiment of the present disclosure. In FIG. 3, the LMF is deployed in the local area/Edge Computing area and is named L-LMF (L-LMF). The L-LMF calculates the UE location and exposes the UE location to a local AF/LCS client. The network function in the core network is not involved during the location calculation procedure.

In addition, the RAN may connect to the L-LMF directly. The transport Network between the RAN and the L-LMF may be based on next generation application protocol (NGAP) and stream control transmission protocol (SCTP). The NGAP association and transport network layer (TNL) association between the RAN and the L-LMF may be established based on a local configuration.

In an embodiment, the L-LMF may not connect to the AMF because the network operator may want to isolate the public network from the local network. Therefore, in the network architecture shown in FIG. 3, the L-LMF is not selected by the AMF and is selected by the AF/LCS client based on the local configuration.

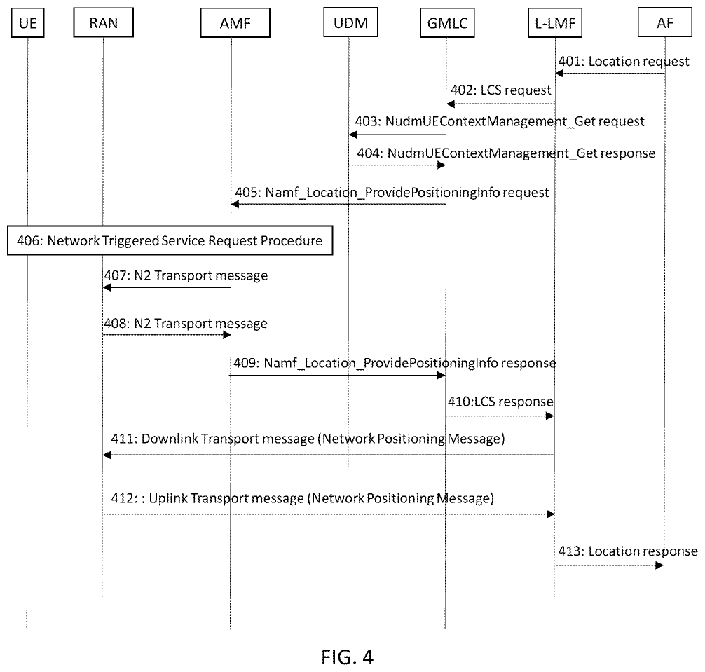

FIG. 4 shows a schematic diagram of a procedure according to an embodiment of the present disclosure. In FIG. 4, the local LCS client requests the UE location information from the L-LMF and the L-LMF communicates the RAN node directly. More specifically, the procedure comprises the following steps:

Step 401: The external location services client (i.e., AF) sends a location request to the L-LMF for a location (e.g., location information) of a target UE. For example, the location request may comprise a GPSI or a SUPI identifying/indicating the target UE.

Step 402: The L-LMF sends an LCS request to the GMLC. If the L-LMF is in untrusted domain, the LCS request may be sent via a network exposure function (NEF) (not shown in FIG. 4). The LCS request message includes the GPSI or SUPI of the target UE. The LCS request may also include a Routing ID of the LMF (e.g., a global address of the LMF).

Step 403: The GMLC invokes a Nudm_UECM_Get service operation towards (e.g., transmits a Nudm_UEContextManagement_Get request to) the home UDM of the target UE, wherein the home UDM may be located with the GPSI or the SUPI of the target UE.

Step 404: The UDM returns a network addresses of an AMF serving the target UE, e.g., in a Nudm_UEContextManagement_Get response.

Step 405: The GMLC invokes a Namf_Location_ProvidePositioningInfo service operation towards (e.g., transmits a Namf_Location_ProvidePositioningInfo request to) the AMF, to request the current location (i.e., location information) of the target UE. The service operation (e.g., Namf_Location_ProvidePositioningInfo request) includes the SUPI, and a client type and may also include the required QoS and supported GAD (Geographical Area Description) shapes. Note that the service operation may also include the Routing ID received in step 402.

Step 406: If the UE is in a connection management idle (CM IDLE) state, the AMF initiates a network triggered Service Request procedure to establish a signaling connection with the UE.

Step 407: The AMF sends an N2 Transport message to the RAN node, wherein the N2 transport message includes the Routing ID of the L-LMF.

Step 408: The RAN node allocates an RAN LCS Correlation ID which identifies the UE context in the RAN node. When the transportation network between the RAN and the LMF is based on the NGAP, the RAN LCS Correlation identifier is the RAN NGAP UE ID. The RAN node sends an N2 Transport message to the AMF, wherein this N2 transport message includes the RAN LCS Correlation ID.

Step 409: The AMF returns a Namf_Location_ProvidePositioningInfo Response towards the GMLC to return the RAN LCS Correlation ID to the GMLC. The service operation may also include node information of the RAN node (e.g., the current UE serving cell ID or RAN node ID).

Step 410: The GMLC sends the RAN LCS Correlation ID and the node information to the L-LMF.

Step 411: The L-LMF selects a TNL association based on the received node information (e.g., UE serving cell ID or RAN node ID). The L-LMF allocates an LMF LCS Correlation ID. When the transportation network between the RAN and the LMF is based on NGAP, the LMF LCS Correlation ID is the LMF NGAP UE ID. The L-LMF then sends a Downlink Transport message over the selected TNL association. The message includes a (downlink) Network Positioning message and the LMF LCS Correlation identifier and the RAN LCS Correlation identifier received in step 410.

Step 412: The RAN node identifies the UE context based on the RAN LCS Correlation identifier and obtains any location information for the target UE. The serving RAN node returns the location information to the L-LMF in a(n) (uplink) Network Positioning message included in an Uplink Transport message via the TNL association. The serving RAN node may also include the LMF LCS Correlation ID in the Uplink Transport message received in step 411.

Step 413: The L-LMF transmits the location information of the UE in a location response to the AF/LCS client. For example, the L-LMF calculates current location of the UE and returns the location estimation, age and accuracy of the location estimation to the AF/LCS client. The L-LMF may also transmit information about the positioning method to the AF/LCS client. Note that step 411 and step 412 may be repeated, to request further location information of the UE.

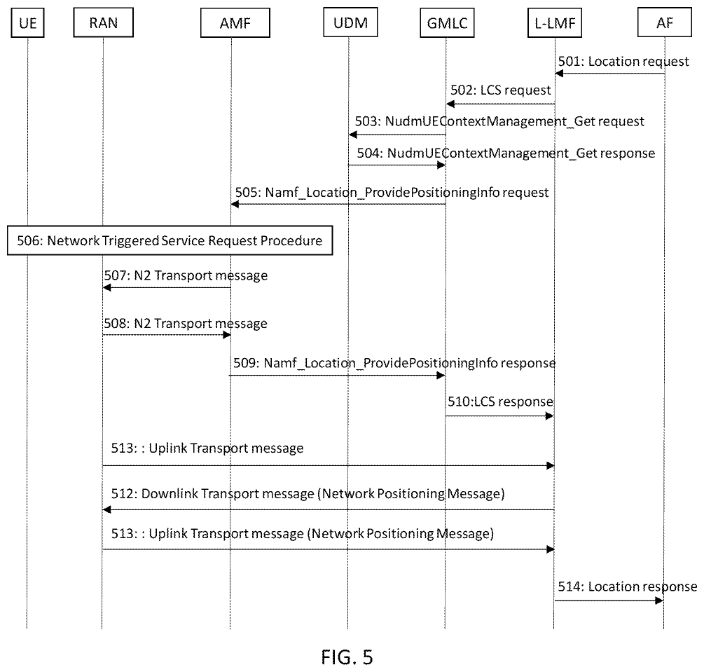

FIG. 5 shows a schematic diagram of a mobile terminated location request procedure according to an embodiment of the present disclosure. The procedure comprises the following steps:

Step 501: The external LCS client/AF sends a location request to the L-LMF for a location (e.g., location information) of a target UE, wherein the target UE may be identified by a GPSI or a SUPI comprised in the location request.

Step 502: The L-LMF sends an LCS request to the GMLC. If the L-LMF is in the untrusted domain, the location request may be sent via an NEF (not shown in FIG. 5). The LCS request includes the GPSI or the SUPI of the target UE. The LCS request may also include a Routing ID identifying/indicating the LMF (e.g., a global address of the LMF) and an LMF LCS Correlation ID. When the transportation network between the RAN and the LMF is based on the NGAP, the LMF LCS Correlation ID is the LMF NGAP UE ID.

Step 503: The GMLC invokes a Nudm_UECM_Get service operation towards (e.g., transmits a NudmUEContextManagement_Get request to) the home UDM of the target UE, wherein the UDM is located based on the GPSI or the SUPI of the target UE.

Step 504: The UDM returns a network address of the current serving AMF of the target UE, e.g., in a NudmUEContextManagement_Get response.

Step 505: The GMLC invokes the Namf_Location_ProvidePositioningInfo service operation towards (e.g., transmits a Namf_Location_ProvidePositioningInfo request to) the AMF, to request the current location (i.e., location information) of the target UE. The service operation includes the SUPI, and client type and may include the required QoS and supported GAD shapes. The service operation may also include the Routing ID and the LMF LCS Correlation ID received in step 502.

Step 506: If the UE is in the CM IDLE state, the AMF initiates a network triggered Service Request procedure to establish a signaling connection with the UE.

Step 507: The AMF sends an N2 Transport message to the RAN node, including the Routing ID and the LMF LCS Correlation ID.

Step 508: The RAN node sends an N2 Transport message back to the AMF.

Step 509: The AMF returns a Namf_Location_ProvidePositioningInfo response towards the GMLC.

Step 510: The GMLC returns an LCS response to the L-LMF.

Step 511: After step 507, the RAN node selects a TNL association towards the LMF based on the Routing ID. The RAN node allocates a RAN LCS Correlation ID which identifies the UE context in the RAN node over the selected TNL association. When the transportation network between the RAN and the LMF is based on the NGAP, the RAN LCS Correlation identifier is the RAN NGAP UE ID. The RAN node sends an uplink transport message (e.g., N2 Transport message) to the L-LMF via the selected TNL association, wherein the uplink transport message includes the RAN LCS Correlation ID and the LMF LCS Correlation ID.

Step 512: The L-LMF stores the RAN LCS Correlation ID. The L-LMF sends a Downlink Transport message over the selected TNL association. The Downlink Transport message includes a (downlink) Network Positioning message, the LMF LCS Correlation identifier and the RAN LCS Correlation identifier received in step 511.

Step 513: The RAN node identifies the UE context according to the RAN LCS Correlation ID and obtains the location information for the target UE. The serving RAN node returns any location information of the target UE to the L-LMF in a(n) (uplink)Network Positioning message included in an Uplink Transport message which is transmitted via the TNL association. The serving RAN node may also include the LMF LCS Correlation ID in the Uplink Transport message.

Step 514: The L-LMF transmits the location information of the target UE to the AF/LCS client in a location response. For instance, the L-LMF calculates current location of the UE and returns the location estimation, age and accuracy of the location estimation and may include information about the positioning method to the AF/LCS client. Note that, step 512 and step 513 may be repeated to request further location information of the target UE.

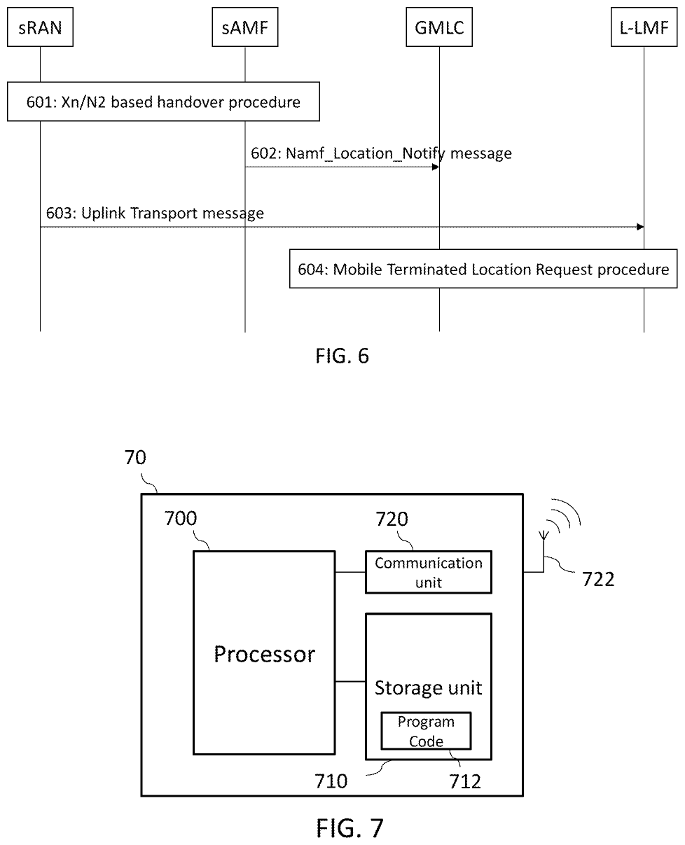

FIG. 6 shows a schematic diagram of a mobility procedure according to an embodiment of the present disclosure. The mobility procedure shown in FIG. 6 comprises the following steps:

Step 601: The source RAN node (i.e., sRAN) of a UE initiates an Xn/N2 based handover procedure for the UE. The UE in this embodiment may be the target UE for the LCS of the L-LMF.

Step 602: The source AMF (i.e., sAMF) serving the target UE sends a Namf_Location_Notify message to the GMLC to notify the handover. If the AMF serving the target UE changes from the sAMF to a target AMF after the handover, this message also indicates the change of the AMF.

Step 603: The sRAN sends an Uplink Transport message to the L-LMF, to indicate the handover of the target UE.

Step 604: Based on the notification from the sRAN, the L-LMF triggers a mobile terminated location request procedure as described in FIG. 4 or FIG. 5, so as to establish a direct connection with the RAN serving the target UE after the handover. As a result, the L-LMF is able to acquire the location information of the target UE and the location information does not expose to the core network. In addition, if the GMLC determines that the AMF serving the UE changes based on the message received in step 602, the GMLC may query the UDM (not shown in FIG. 6) for the latest serving AMF address.

FIG. 7 relates to a schematic diagram of a wireless terminal 70 according to an embodiment of the present disclosure. The wireless terminal 70 may be a user equipment (UE), a mobile phone, a laptop, a tablet computer, an electronic book or a portable computer system and is not limited herein. The wireless terminal 70 may include a processor 700 such as a microprocessor or Application Specific Integrated Circuit (ASIC), a storage unit 710 and a communication unit 720. The storage unit 710 may be any data storage device that stores a program code 712, which is accessed and executed by the processor 700. Embodiments of the storage unit 712 include but are not limited to a subscriber identity module (SIM), read-only memory (ROM), flash memory, random-access memory (RAM), hard-disk, and optical data storage device. The communication unit 720 may a transceiver and is used to transmit and receive signals (e.g., messages or packets) according to processing results of the processor 700. In an embodiment, the communication unit 720 transmits and receives the signals via at least one antenna 722 shown in FIG. 7.

In an embodiment, the storage unit 710 and the program code 712 may be omitted and the processor 700 may include a storage unit with stored program code.

The processor 700 may implement any one of the steps in exemplified embodiments on the wireless terminal 70, e.g., by executing the program code 712.

The communication unit 720 may be a transceiver. The communication unit 720 may as an alternative or in addition be combining a transmitting unit and a receiving unit configured to transmit and to receive, respectively, signals to and from a wireless network node (e.g., a base station).

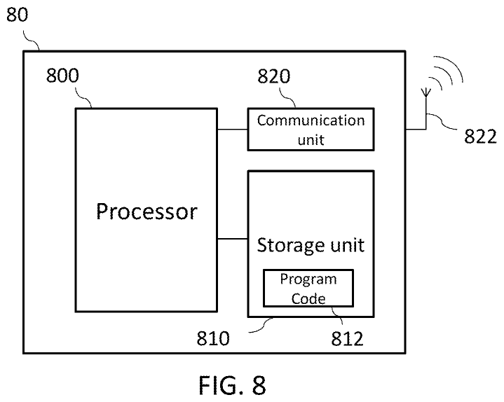

FIG. 8 relates to a schematic diagram of a wireless network node 80 according to an embodiment of the present disclosure. The wireless network node 80 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 80 may comprise (perform) at least one network function such as an access and mobility management function (AMF), a session management function (SMF), a user place function (UPF), a policy control function (PCF), an application function (AF), etc. The wireless network node 80 may include a processor 800 such as a microprocessor or ASIC, a storage unit 810 and a communication unit 820. The storage unit 810 may be any data storage device that stores a program code 812, which is accessed and executed by the processor 800. Examples of the storage unit 812 include but are not limited to a SIM, ROM, flash memory, RAM, hard-disk, and optical data storage device. The communication unit 820 may be a transceiver and is used to transmit and receive signals (e.g., messages or packets) according to processing results of the processor 800. In an example, the communication unit 820 transmits and receives the signals via at least one antenna 822 shown in FIG. 8.

In an embodiment, the storage unit 810 and the program code 812 may be omitted. The processor 800 may include a storage unit with stored program code.

The processor 800 may implement any steps described in exemplified embodiments on the wireless network node 80, e.g., via executing the program code 812.

The communication unit 820 may be a transceiver. The communication unit 820 may as an alternative or in addition be combining a transmitting unit and a receiving unit configured to transmit and to receive, respectively, signals to and from a wireless terminal (e.g., a user equipment or another wireless network node).

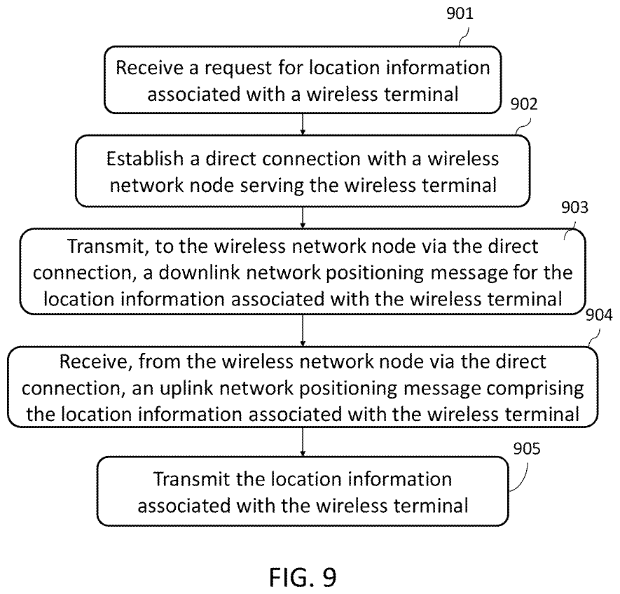

FIG. 9 shows a flowchart of a method according to an embodiment of the present disclosure. The method shown in FIG. 9 may be used in an LMF (e.g., L-LMF, a wireless device comprising LMF/L-LMF or a wireless device performing functionalities of LMF/L-LMF) and comprises the following steps:

Step 901: Receive a request for location information associated with a wireless terminal.

Step 902: Establish a direct connection with a wireless network node serving the wireless terminal.

Step 903: Transmit, to the wireless network node via the direct connection, a downlink network positioning message for the location information associated with the wireless terminal.

Step 904: Receive, from the wireless network node via the direct connection, an uplink network positioning message comprising the location information associated with the wireless terminal.

Step 905: Transmit the location information associated with the wireless terminal.

In FIG. 9, the LMF receives a request for location information associated with a wireless terminal (e.g., UE). For example, the LMF may receive the request from an AF/LCS client (e.g., step 401 or 501). In order not to expose the location information to the core network (functions), the LMF establishes a direct connection with a wireless network node (e.g., RAN node) serving the wireless terminal. Via the direct connection, the LMF is able to transmit and receive network positioning messages (i.e., downlink/uplink network positioning messages) for acquiring the location information of the wireless terminal (steps 903 and 904). The LMF may further transmit the received location information, e.g., to the AF/LCS client.

In an embodiment, to establish the direct connection, the LMF receives, from the wireless network node, a node correlation ID (e.g. RAN LCS Correlation ID) associated with (identifying/indicating) the wireless terminal at the wireless network node and/or transmits, to the wireless network node, a function correlation ID (e.g. LMF LCS Correlation ID) associated with (identifying/indicating) the request or the procedure for the location information at the LMF. In an embodiment, the downlink network positioning message transmitted from the LMF to the wireless network node via the direct connection comprises the node correlation ID and may further comprises the function correlation ID. In addition, the uplink positioning message transmitted from the wireless network node to the LMF via the direct connection comprises the function correlation ID and may further comprises the node correlation ID.

For example, the LMF receives, from the wireless network node via at least one core network function, node information of the wireless network node and the node correlation ID (e.g., steps 402 to 410). Based on the node information, the LMF establishes the direct connection (e.g., a TNL connection). Via the established direct connection, the LMF transmits the function correlation ID to the wireless network node. In this embodiment, the LMF may transmit a routing ID of the LMF to the wireless network node.

As an alternative, the LMF transmits, to the wireless network node via at least one core network function, the routing ID of the LMF and the function correlation ID (e.g., steps 502 to 507). Based on the routing ID, the wireless network node establishes the direct connection and transmits the node correlation ID to the LMF via the direct connection (e.g., step 511).

In an embodiment, the node correlation ID and/or the function correlation ID is the NGAP UE ID of the wireless terminal.

In an embodiment, the LMF receives a transport message (e.g., an indication) indicating that a handover (e.g., Xn/N2 based handover) associated with the wireless terminal is performed, e.g., due to mobility of the wireless terminal. In this embodiment, the wireless network node serving the wireless network node may change to be a target network node. In order to acquire the location information of the wireless terminal, the LMF may establishes a direct connection with the target wireless network node. For example, the LMF may perform the procedure shown in FIG. 4 or 5 with the target wireless network node.

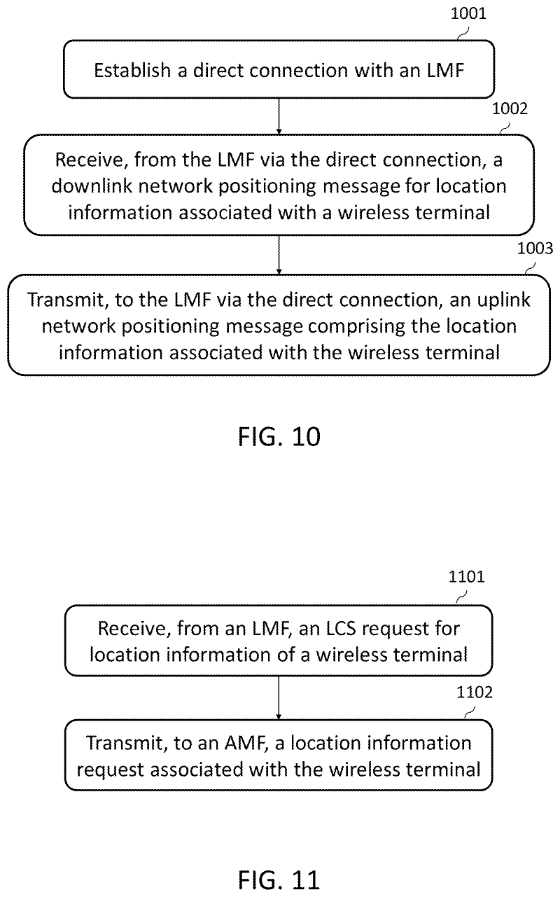

FIG. 10 shows a flowchart of a method according to an embodiment of the present disclosure. The method shown in FIG. 10 may be used in a wireless network node (e.g., RAN node) and comprises the following steps:

Step 1001: Establish a direct connection with an LMF.

Step 1002: Receive, from the LMF via the direct connection, a downlink network positioning message for location information associated with a wireless terminal.

Step 1003: Transmit, to the LMF via the direct connection, an uplink network positioning message comprising the location information associated with the wireless terminal.

More specifically, the wireless network node establishes a direct connection with an LMF (e.g., L-LMF). Via the direct connection, the wireless network node is able to transmit and receive network positioning messages (i.e., downlink/uplink network positioning messages) for transmitting the location information of the wireless terminal to the LMF (steps 1002 and 1003). The location information is therefore not exposed to the core network (functions).

In an embodiment, for establishing the direct connection, the wireless network transmits, to the LMF, a node correlation ID (e.g. RAN LCS Correlation ID) associated with (identifying/indicating) the wireless terminal at the wireless network node and/or receives, from the LMF, a function correlation ID (e.g. LMF LCS Correlation ID) associated with (identifying/indicating) the request or the procedure for the location information at the LMF. In an embodiment, the downlink network positioning message transmitted from the LMF to the wireless network node via the direct connection comprises the node correlation ID and may further comprises the function correlation ID. In addition, the uplink positioning message transmitted from the wireless network node to the LMF via the direct connection comprises the function correlation ID and may further comprises the node correlation ID.

For example, the wireless network node transmits, to the LMF via at least one core network function, node information of the wireless network node and the node correlation ID (e.g., steps 402 to 410). Based on the node information, the LMF establishes the direct connection (e.g., a TNL connection). Via the established direct connection, the wireless network node receives the function correlation ID from the LMF. In this embodiment, the wireless network node may receive a routing ID of the LMF (see, e.g., steps 402 to 407).

As an alternative, the wireless network node receives, from the LMF via at least one core network function, the routing ID of the LMF and the function correlation ID (e.g., steps 502 to 507). Based on the routing ID, the wireless network node establishes the direct connection and transmits the node correlation ID to the LMF via the direct connection (e.g., step 511).

In an embodiment, the node correlation ID and/or the function correlation ID is the NGAP UE ID of the wireless terminal.

In an embodiment, the wireless network node transmits a transport message (e.g., an indication) indicating that a handover (e.g., Xn/N2 based handover) associated with the wireless terminal is performed, e.g., due to mobility of the wireless terminal. In this embodiment, the wireless network node serving the wireless network node may change to be a target network node because of the handover. In order to acquire the location information of the wireless terminal, the LMF may establishes a direct connection with the target wireless network node. For example, the LMF may perform the procedure shown in FIG. 4 or 5 with the target wireless network node.

FIG. 11 shows a flowchart of a method according to an embodiment of the present disclosure. The method shown in FIG. 11 may be used in a GMLC (e.g., a wireless device comprising the GMLC or a wireless network performing functionalities of the GMLC) and comprises the flowing steps:

Step 1101: Receive, from an LMF, an LCS request for location information of a wireless terminal.

Step 1102: Transmit, to an AMF, a location information request associated with the wireless terminal.

In FIG. 11, the GMLC receives an LCS request for location information of a wireless terminal. Note that the LCS request comprises a routing ID associated with the LMF. The GMLC transmits a location information request associated with the wireless terminal to an AMF, wherein the location information request comprises the routing ID.

In an embodiment, the GMLC receives, from the AMF, a location information response comprising node information of a wireless network node (serving the wireless terminal) and a node correlation ID associated with (identifying/indicating) the wireless terminal at the wireless network node. The GMLC transmits the node information and the node correlation ID to the LMF, to allow the LMF establish a direct connection with the wireless network node.

In an embodiment, the location service request and the location information request comprise a function correlation ID associated with a request for the location information at the LMF. In this embodiment, the wireless network node serving the wireless terminal may establish a direct connection with the LMF based on the routing ID.

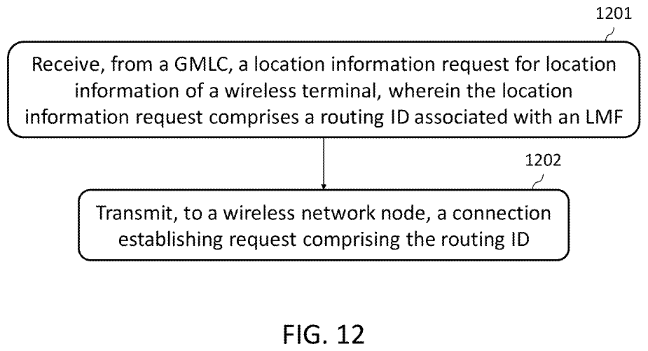

FIG. 12 shows a flowchart of a method according to an embodiment of the present disclosure. The method shown in FIG. 12 may be used in an AMF (e.g., a wireless device comprising the AMF or a wireless device performing functionalities of the AMF) and comprises the following steps:

Step 1201: Receive, from a GMLC, a location information request for location information of a wireless terminal, wherein the location information request comprises a routing ID associated with an LMF.

Step 1202: Transmit, to a wireless network node, a connection establishing request comprising the routing ID.

In FIG. 12, the AMF receives a location information request for location information of a wireless terminal from a GMLC. The location information request comprises a routing ID of an LMF. The AMF then transmits a connection establishing request (e.g., an N2 Transport message) comprising the routing ID to a wireless network node serving the wireless terminal.

In an embodiment, the AMF receives, from the wireless network node, a connection establishing response (e.g., N2 Transport message) comprising a node correlation ID associated with (identifying/indicating) the wireless terminal at the wireless network node. The AMF transmits node information of the wireless network node and the node correlation ID to the GMLC in a location information response.

In an embodiment, the location information request and the connection establishing request comprise a function correlation ID associated with identifying/indicating a request for the location information at the LMF.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method for use in a location management function, the wireless communication method comprising:
receiving a request for location information associated with a wireless terminal,
establishing a direct connection with a wireless network node serving the wireless terminal,
transmitting, to the wireless network node via the direct connection, a downlink network positioning message for the location information associated with the wireless terminal,
receiving, from the wireless network node via the direct connection, an uplink network positioning message comprising the location information associated with the wireless terminal, and
transmitting the location information associated with the wireless terminal.

2. The wireless communication method of claim 1, wherein establishing the direct connection with the wireless network node serving the wireless terminal comprises:
receiving, from the wireless network node via at least one core network function, node information of the wireless network node and a node correlation identifier associated with the wireless terminal at the wireless network node, and
transmitting, to the wireless network node via the direct connection, a function correlation identifier associated with the request for the location information at the location management function.

3. The wireless communication method of claim 2, wherein the direct connection is established by the location management function based on the node information of the wireless network node.

4. The wireless communication method of claim 2, further comprising:
transmitting, to the wireless network node via the at least one core network function, a routing identifier associated with the location management function.

5. The wireless communication method of claim 1, wherein establishing the direct connection with the wireless network node serving the wireless terminal comprises:
transmitting, to the wireless network node via at least one core network function, a routing identifier associated with the location management function and a function correlation identifier associated with the request for the location information at the location management function, and
receiving, from the wireless network node via the direct connection, a node correlation identifier associated with the wireless terminal at the wireless network node.

6. The wireless communication method of claim 2, wherein the node correlation identifier and the function correlation identifier are next generation application protocol user equipment identifiers of the wireless terminal.

7. The wireless communication method of claim 1, further comprising:
receiving, from the wireless network node, a transport message indicating a handover associated with the wireless terminal, and
establishing a direct connection with a target wireless network node of the handover.

8. A wireless communication method for use in a wireless network node, the wireless communication method comprising:
establishing a direct connection with a location management function,
receiving, from the location management function via the direct connection, a downlink network positioning message for location information associated with a wireless terminal, and
transmitting, to the location management function via the direct connection, an uplink network positioning message comprising the location information associated with the wireless terminal.

9. The wireless communication method of claim 8, wherein establishing the direct connection with the location management function comprises:
transmitting, to the location management function via at least one core network function, node information of the wireless network node and a node correlation identifier associated with the wireless terminal at the wireless network node, and
receiving, from the location management function via the direct connection, a function correlation identifier associated with the request for the location information at the location management function.

10. The wireless communication method of claim 9, further comprising:
receiving, from the location management function via the at least one core network function, a routing identifier associated with the location management function.

11. The wireless communication method of claim 8, wherein establishing the direct connection with the location management function comprises:
receiving, from the location management function via at least one core network function, a routing identifier associated with the location management function and a function correlation identifier associated with the request for the location information at the location management function, and
transmitting, to the location management function via the direct connection, a node correlation identifier associated with the wireless terminal at the wireless network node.

12. The wireless communication method of claim 11, wherein the direct link is established by the wireless network node based on the routing identifier.

13. The wireless communication method of claim 9, wherein the node correlation identifier and the function correlation identifier are next generation application protocol user equipment identifiers of the wireless terminal.

14. The wireless communication method of claim 8, wherein a handover associated with the wireless network node is performed, and
wherein the wireless communication method further comprises:
transmitting, to the location management function, a transport message indicating the handover.

15. A wireless communication method for use in a gateway mobile location centre, the wireless communication method comprising:
receiving, from a location management function, a location service request for location information of a wireless terminal, wherein the location service request comprises a routing identifier associated with the location management function, and
transmitting, to an access and mobility management function, a location information request associated with the wireless terminal, wherein the location information request comprises the routing identifier.

16. The wireless communication method of claim 15, further comprising:
receiving, from the access and mobility management function, a location information response comprising node information of a wireless network node and a node correlation identifier associated with the wireless terminal at the wireless network node, and
transmitting, to the location management function, a location service response comprising the node information and the node correlation identifier.

17. The wireless communication method of claim 15, wherein the location service request and the location information request comprise a function correlation identifier associated with a request for the location information at the location management function.

18. The wireless communication method of claim 15, wherein the location information request and the connection establishing request comprise a function correlation identifier associated with identifying a request for the location information at the location management function.
